(19) United States
(12) Patent Application Publication
(10) Pub. No.: US 2025/0133006 A1
(43) Pub. Date: Apr. 24, 2025

(54) NETWORK PATH SELECTION BASED ON AGGREGATE INDICATORS

(71) Applicant: HEWLETT PACKARD ENTERPRISE DEVELOPMENT LP, Spring, TX (US)

(72) Inventors: Isaac Theogaraj, Bangalore (IN); Gopal Gupta, Bangalore (IN)

(21) Appl. No.: 18/601,599

(22) Filed: Mar. 11, 2024

(30) Foreign Application Priority Data
Oct. 20, 2023 (IN) 202341071768

(51) Int. Cl. H04L 45/12; H04L 43/0829; H04L 43/087; H04L 43/0882; H04L 45/00; H04L 45/02

(52) U.S. Cl. CPC H04L 45/124; H04L 43/0829; H04L 43/087; H04L 43/0882; H04L 45/08; H04L 45/26

(57) ABSTRACT

In some examples, a network device receives first indicators of performances of a plurality of computing environments, and receives second indicators of performances of a plurality of network paths from the network device to the computing environments. The network device aggregates the first indicators and second indicators to produce aggregate indicators of performances of the network paths. The network device selects, based on the aggregate indicators, a selected network path of the plurality of network paths for communication of data through the network device between a client and a computing environment of the plurality of computing environments.

### BACKGROUND

Computing environments such as data centers, cloud environments, or other types of computing environments can provide services for clients. The clients are able to access the computing environments over a network.

### BRIEF DESCRIPTION OF THE DRAWINGS

Some implementations of the present disclosure are described with respect to the following figures.

FIG. 1 is a block diagram of an arrangement that includes a branch gateway that controls the use of network paths from clients to computing environments, court some examples.

FIG. 2 is a flow diagram of a process of the branch gateway according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Clients can communicate data with various computing environments through network devices of a network. Examples of network devices include switches, wireless access points, gateways, concentrators, or other network devices. A software defined wide area network (SD-WAN) can be used to manage which network paths to use for data communications between a client and a computing environment. In the SD-WAN, software can be run on a network device, such as a branch gateway, to select which network path to use for any given client. A branch gateway is a type of an edge router and can be coupled over multiple network paths to computing environments. Clients can be selectively connected by the branch gateway to different computing environments to provide improved performance and reliability. In some cases, the branch gateway may prioritize data of higher priority clients by selecting network paths with greater performance to communicate data for the higher priority clients. However, the distribution of the data traffic load across the network paths may be statically configured and thus may not dynamically adjust to changing conditions of the network paths and the computing environments. As a result, data communication performance may suffer.

In accordance with some implementations of the present disclosure, when distributing data traffic across network paths to different computing environments, a network device such as a branch gateway can consider performance indicators of network paths between the network device and the computing environments as well as performance indicators of computing environments. The network path performance indicators and the computing environment performance indicators can be aggregated to produce aggregate performance indicators, which are then used by the network device in selecting a network path to a selected computing environment to communicate data of a given client. In some examples, the performance indicators are derived based on computing baselines of values of metrics and standard deviations computed relative to the baselines.

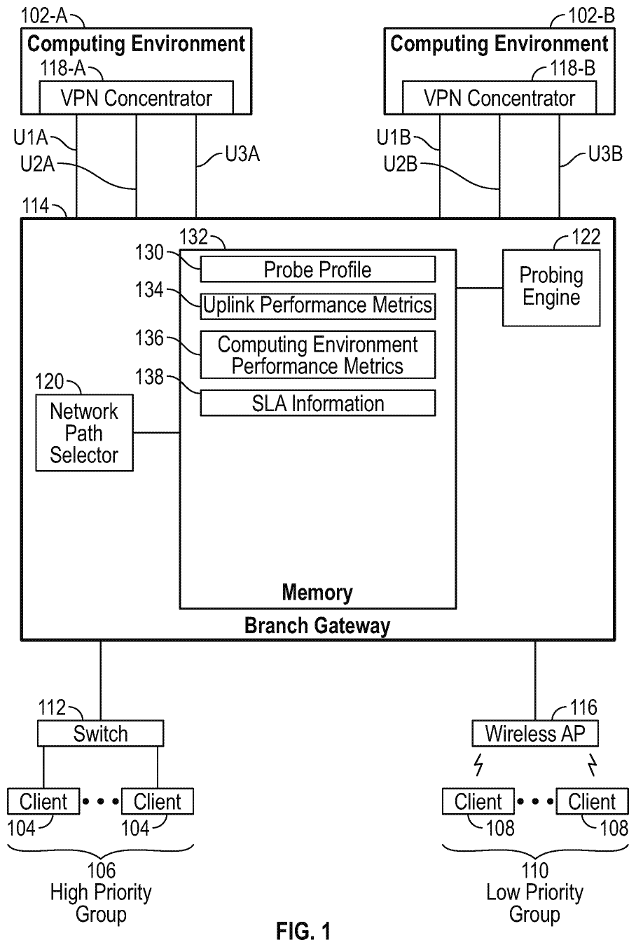

FIG. 1 is a block diagram of an example network arrangement that includes computing environments 102-A and 102-B to which various clients can communicate. In some examples, the network arrangement of FIG. 1 includes an SD-WAN. In other examples, other types of network arrangements are employed.

A “client” can refer to a program or a machine. For example, a program can include an application program, an operating system (OS), a virtual machine, a container, or any other type of program. A machine can include a computer (e.g., a desktop computer, a server computer, a notebook computer, a tablet computer, etc.), a smartphone, a game appliance, an Internet of Things (IoT) device, a household appliance, a vehicle, or any other type of electronic device.

In the example of FIG. 1, clients 104 are part of a high-priority group 106, and clients 108 are part of a low-priority group 110. The terms “high-priority group” and “low-priority group” are to indicate the relative priorities of different groups of clients. A high-priority group has a higher priority than another group of clients. A low-priority group has a lower priority than another group of clients. Although just two priority groups are shown in FIG. 1, in other examples, there may be additional priority groups that have different relative priorities to one another. A group of clients can include a single client or multiple clients. A client can be assigned to a given priority group by a human (e.g., an administrator), a program, or a machine.

In examples according to FIG. 1, the clients 104 are connected through a switch 112 to a branch gateway 114. A switch refers to a forwarding device that can forward packets based on network addresses in the data packets, such as layer 2 network addresses (e.g., Media Access Control (MAC) addresses) or layer 3 network addresses (e.g., Internet Protocol (IP) addresses). A switch that routes packets based on layer 3 network addresses can also be referred to as a router. In other examples, a switch can forward packets based on other forwarding information, such as labels, for example.

The clients 108 are coupled over wireless links to a wireless access point (AP) 116, which is connected to the branch gateway 114. The wireless AP 116 may be part of a wireless local area network (WLAN), for example.

More generally, clients are coupled to network devices to allow the clients to communicate with target entities, such as computing environments 102-A and 102-B. The computing environments 102-A and 102-B can include any or some combination of the following: cloud environments, data centers, or any other computing environments including resources (e.g., services, hardware resources, etc.) accessible by the clients. Although just two computing environments are depicted in FIG. 1, in other examples, more than two computing environments may be present.

A priority of a client can be based on the priority of a user of the client. Different users may be associated with different priorities. A client used by a high-priority user would be assigned to the high-priority group, while a client used by a low-priority user would be assigned to the low-priority group. For example, users may have priority ratings from a range of priority ratings (e.g., range of 1 to 10 or another range).

When a new client associates with a network device, such as the switch 112 or the wireless AP 116, a determination is made regarding the priority of the user of the new client. Based on the determined priority of the user, the new client is assigned to a given priority group (e.g., 106 or 110).

Each of the clients 104, 108 is able to communicate data in an uplink direction from a client to a computing environment or in a downlink direction from a computing environment to the client. The branch gateway 114 can be implemented using a collection of computer systems, which can include a single computer system or multiple computer systems. The branch gateway 114 (or more generally, a network device) can selectively use different network paths for communicating data between clients and computing environments based on aggregate performance indicators as discussed further below.

In the present discussion according to some examples, reference is made to the branch gateway 114 selecting different uplinks U1A, U2A, U3A, U1B, U2B, U3B to the computing environment 102-A and 102-B. Selecting an uplink refers to selecting a network path to communicate data from a client to a computing environment.

It is noted that techniques or mechanisms according to some implementations of the present disclosure can also be applied to selecting downlinks for communicating data from a computing environment to a client. The uplinks and downlinks are network paths between the branch gateway 114 and the computing environments 102-A and 102-B. More generally, the branch gateway 114 can select network paths between the branch gateway 114 and the computing environments 102-A and 102-B based on aggregate performance indicators for communication of traffic (uplink traffic and/or downlink traffic) between clients and the computing environments 102-A and 102-B.

In the example of FIG. 1, there are three uplinks between the branch gateway 114 and each of the computing environments 102-A and 102-B. Specifically, uplinks U1A, U2A, and U3A are connected between the branch gateway 114 and the computing environment 102-A, and uplinks U1B, U2B, and U3B are connected between the branch gateway 114 and the computing environment 102-B. In different examples, a different quantity of uplinks (or more generally network paths) can be connected between the branch gateway 114 and a computing environment.

The uplinks U1A, U2A, U3A are connected to a virtual private network (VPN) concentrator 118-A of the computing environment 102-A, and the uplinks U1B, U2B, U3B are connected to a VPN concentrator 118-B of the computing environment 102-B. A VPN concentrator refers to a network device that manages multiple VPN connections from clients to the computing environment.

Although reference is made to VPN concentrators as examples of network devices to which the uplinks are connected, in other examples, the uplinks U1A, U2A, U3A, U1B, U2B, and U3B can be connected to different network devices of the computing environments 102-A and 102-B.

In accordance with some examples of the present disclosure, the branch gateway 114 includes a network path selector 120 that dynamically controls how clients are connected to respective computing environments 102-A and 102-B. The network path selector 120 can collect performance indicators of the uplinks (U1A, U2A, U3A, U1B, U2B, U3B), and performance indicators of the computing environments 102-A, 102-B. The network path selector 120 uses the collected performance indicators as well as service-related information associated with clients to select uplinks to use for communicating data from the clients to selected computing environments. As discussed further below, the service-related information can include service level agreement (SLA) information associated with clients.

The performance indicators obtained by the network path selector 120 can be based on probes sent by a probing engine 122 of the branch gateway 114. The probing engine 122 can send probe packets over the uplinks to the computing environments 102-A and 102-B. A “packet” can refer to any unit of data that can be separately transmitted from a source to a destination.

Each of the network path selector 120 and the probing engine 122 can be implemented with one or more hardware processing circuits, which can include any or some combination of a microprocessor, a core of a multi-core microprocessor, a microcontroller, a programmable integrated circuit, a programmable gate array, or another hardware processing circuit. Alternatively, each of the network path selector 120 and the probing engine 122 can be implemented with a combination of one or more hardware processing circuits and machine-readable instructions (software and/or firmware) executable on the one or more hardware processing circuits.

Although FIG. 1 shows the probing engine 122 as being part of the branch gateway 114, in other examples, the probing engine 122 can be separate from the branch gateway 114.

The probing engine 122 can send probe packets over the uplinks U1A, U2A, U3A, U1B, U2B, and U3B to the computing environments 102-A and 102-B. The probe packets can be according to a probe profile 130 stored in a memory 132 of the branch gateway 114. The memory 132 can be implemented using one or more memory devices, such as any or some combination of a dynamic random access memory (DRAM) device, a static random access memory (SRAM) device, a flash memory device, or another type of memory device.

In some examples, the probe profile 130 can include any or some combination of the following: information specifying a type of probe packet to use; target addresses to which probe packets are to be sent; probe burst information specifying a quantity of probe packets to be sent simultaneously; probe retry information specifying how many times a probe packet is to be retried if no response is received; a probe interval specifying a time period between sending of bursts of probe packets; or any other information relating to characteristics of probe packets and the manner in which probe packets are communicated.

In some examples, a type of probe packet specified by the probe profile 130 is a User Datagram Protocol (UDP) packet, such as an Internet Control Message Protocol (ICMP) packet that is used for performing network diagnostics. In other examples, other types of probe packets can be specified by the probe profile 130.

Based on the probe packets sent by the probing engine 122, monitoring agents (not shown) in a network including the uplinks U1A, U2A, U3A, U1B, U2B, and U3B and monitoring agents (not shown) in the computing environments 102-A and 102-B can obtain measured performance metrics associated with performance of the uplinks U1A, U2A, U3A, U1B, U2B, and U3B and the computing environments 102-A and 102-B. The monitoring agents can be in the form of hardware or software sensors, machine-readable instructions executed in electronic devices, or other types of monitoring agents.

The measured performance metrics can be provided by the monitoring agents to the probing engine 122, which can store uplink performance metrics 134 and computing environment performance metrics 136 in the memory 132.

Examples of the uplink performance metrics 134 include any or some combination of the following: bandwidth utilization, jitter, latency, packet loss, or any other metric that provides an indication of how an uplink is performing. The bandwidth utilization of a network path (e.g., an uplink and/or a downlink) can refer to a what percentage of the total bandwidth of the network path is being used for traffic communications. The jitter of a network path can refer to a variance in latency of the network path. The latency of a network path can refer to a time delay in data communicated over the network path. The packet loss can refer to how many packets transmitted over the network path are lost, which can be expressed as a percentage of packets lost, a quantity of packets lost per unit time, or any other indicator of loss of packets.

Examples of the computing environment performance metrics 136 include any or some combination of the following: a bandwidth factor, power usage effectiveness, energy efficiency, reliability, throughput, or any other metric that provides an indication of how a computing environment is performing. The bandwidth factor of a computing environment can refer to the amount of network bandwidth or capacity that is available for data transfer within the computing environment or between the computing environment and external networks. This bandwidth factor indicates how smoothly data communications can perform in the computing environment.

The power usage effectiveness (PUE) of a computing environment assesses the energy efficiency of a computing environment. The PUE measures how effectively a computing environment uses energy. For example, the PUE can be based on relative energy usage of cooling and other support systems as compared to the energy usage of information technology (IT) equipment such as servers, storage systems, network devices, and so forth. A lower PUE value indicates better energy efficiency, for example.

The network energy efficiency of computing environment measures how effectively the computing environment's network infrastructure and operations use energy to support data communication and transfer.

The reliability of a computing environment provides an indication of reliability of services, data, and resources of the computing environment. A higher reliability can indicate that an increased likelihood that the services, data, and resources of the computing environment will be continuously available (i.e., will not be unavailable for extended time periods). The reliability of the computing environment can indicate the ability of the computing environment to perform its tasks without interruption or failure.

The throughput of a computing environment can refer to any or some combination of: data throughput relating to data communications in the computing environment, throughput of machine-readable instructions or hardware resources when performing tasks, or other indicators of how quickly the computing environment is performing tasks.

Other examples of computing environment performance metrics include: heating, ventilation, and air conditioning (HVAC) efficiency (representing an efficiency of an HVAC system in a computing environment); a greenness measure (representing a carbon footprint of the computing environment); a security measure (representing a level of security in the computing environment); a financial impact measure (representing a financial impact associated with an outage of the computing environment and other costs associated with the computing environment); and so forth.

The memory 132 can also store SLA information 138 associated with a data flow. The data flow may be identified by the following combination of information elements: a source Internet Protocol (IP) address, a destination IP address, a protocol (used by data in the data flow), a source port, and a destination port. The SLA information 138 can also include category information indicating a category of the data flow. Examples of categories of data flows can include any or some combination of the following: voice-over-IP communications, communications of sensitive data, web browsing, social media access, and so forth.

The SLA information 138 may also include a threshold profile, which includes thresholds for various performance metrics (including performance metrics of network paths such as uplinks). The network path selector 120 can consider whether measured performance metrics satisfy thresholds in the threshold profile as part of selecting network paths for communication of traffic of a client. Different data flows may be associated with different SLA information 138 having different threshold profiles.

For communicating traffic from a given set of clients (a single client or multiple clients), there are six possible uplinks in the example of FIG. 1, including the three uplinks U1A, U2A, and U3A to the computing environment 102-A, and the three uplinks U1B, U2B, and U3B to the computing environment 102-B. Rather than select an uplink for the given set of clients based on just performance metrics associated with the uplinks U1A, U2A, U3A, U1B, U2B, and U3B, the network path selector 120 according to some examples of the present disclosure also considers performance metrics associated with the computing environments 102-A and 102-B when selecting one of the uplinks U1A, U2A, U3A, U1B, U2B, and U3B for communicating traffic from the given set of clients.

The performance metrics associated with the uplinks and performance metrics associated with the computing environments are aggregated to produce aggregate performance metrics, and the network path selector 120 uses the aggregate performance metrics to select which uplink to use for communicating traffic of the client. Selecting network paths to use based on aggregate performance metrics is referred to as aggregate performance-based network path selection.

In some examples, the network path selector 120 applies aggregate performance-based network path selection for high-priority clients, such as the clients 104 of the high-priority group 106. However, the network path selector 120 does not apply aggregate performance-based network path selection for low-priority clients, such as the clients 108 of the low-priority group 110. More generally, the network path selector 120 applies aggregate performance-based network path selection for clients of groups associated with a priority level that exceeds a specified threshold priority, and does not apply aggregate performance-based network path selection for clients of groups associated with a priority level that does not exceed the specified threshold priority. For groups of clients (e.g., the low-priority group 110) for which the network path selector 120 does not apply aggregate performance-based network path selection, best effort network path selection can be applied in which network paths with available bandwidth are assigned to such clients.

In some cases, the network path selector 120 may select multiple uplinks for a given set of clients based on application of the aggregate performance-based network path selection. These multiple uplinks are referred to as “choice uplinks,” and traffic from the given set of clients can be distributed across the choice uplinks for load balancing and/or redundancy.

In computing an aggregate performance metric, the network path selector 120 according to some examples of the present disclosure can perform the following: (1) compute a deviation-based uplink metric based one or more performance metrics of an uplink, (2) compute a computing environment metric based on one or more performance metrics of a computing environment connected to the uplink, and (3) aggregate the deviation-based uplink metric and the computing environment metric (discussed further below).

Computing a deviation-based uplink metric based on a performance metric involves calculating a baseline of values of the performance metric, and calculating a standard deviation of the values of the performance metric from the baseline. A baseline of values of the performance metric is derived by applying a baselining algorithm, which is explained further below.

Once the baseline is computed, the standard deviation of the values of the performance metric from the baseline can be computed, such as according to Eq. 1 below:

$$σ = \sqrt{\frac{1}{N} {\sum }_{i = 1}^{N} ( {X}_{i} - μ )} , \qquad ( Eq . 1 )$$

where σ represents the standard deviation, μ represents the baseline, N represents the total number of observed performance metric values, and Xᵢ represents a performance metric value.

The following tables illustrate an example of performance metric values associated with uplinks and computing environments, and how the performance metric values can be used to derive performance scores of uplinks and computing environments. Although specific values are included in the tables, note that these are provided for purposes of example, as different scenarios would result in different values.

The following refers to an example with four uplinks (U1, U2, U3, U4) and two datacenters (DC1, DC2). Uplinks U1 and U2 are connected to datacenter DC1, and uplinks U3 and U4 are connected to datacenter DC2.

For a given set of clients, the network path selector 120 identifies uplinks with performance metrics that satisfy the threshold profile for the data flow of the given set of clients, where the threshold profile is included in SLA information 138 for the data flow. Any uplinks with performance metrics that do not satisfy the threshold profile are disregarded by the network path selector 120. In the example discussed here, it is assumed that each of uplinks U1, U2, U3, and U4 has performance metrics (e.g., any or some combination of bandwidth utilization, jitter, latency, and packet loss) that satisfy respective thresholds (e.g., bandwidth utilization threshold, jitter threshold, latency threshold, and packet loss threshold) in the threshold profile for the data flow. For example, a particular uplink is disregarded if the bandwidth utilization of the particular uplink does not satisfy the bandwidth utilization threshold, the jitter of the particular uplink does not satisfy the jitter threshold, the latency of the particular uplink does not satisfy the latency threshold, and/or the packet loss of the particular uplink does not satisfy the packet loss threshold.

Table 1 below includes four columns representing the bandwidth utilization, jitter, latency, and packet loss of uplink U1. Although four specific performance metrics are depicted, it is noted that in different examples different performance metrics may be employed.

For each of the performance metrics in the four columns of Table 1, performance metric values observed at times t1, t2, t3, t4, t5, . . . , tz are listed. Note that there may be many more observed performance metric values at additional time points.

TABLE 1
(Uplink U1)

| | Bandwidth | | | |
|---|---|---|---|---|
| | Utilization | Jitter | Latency | Packet Loss |
| | (%) | (millisecond) | (millisecond) | (%) |
| t1 | 10 | 3.750 | 20.0 | 0.16875 |
| t2 | 73 | 30.000 | 145.0 | 0.91875 |
| t3 | 76 | 112.500 | 55.0 | 0.18750 |
| t4 | 47 | 75.000 | 110.0 | 0.84375 |
| t5 | 30 | 54.375 | 67.5 | 0.07500 |
| . . . | | | | |
| tz | . . . | . . . | . . . | . . . |
| Baseline | 41 | 106.87 | 122.5 | 0.8010 |
| Standard | 25.1984 | 37.3044 | 43.6004 | 0.3587 |
| Deviation | | | | |
| Normalized | 0.114996494 | 0.048205837 | −0.059723306 | −0.147319904 |
| Standard | | | | |
| Deviation | | | | |

The “Baseline” row of Table 1 includes the baseline values derived for each of the four performance metrics for uplink U1, based on the observed metric values at the different time points. Thus, for example, the baseline of the bandwidth utilization metric is derived from the observed bandwidth utilization metric values at t1, t2, t3, t4, t5, . . . , tz; the baseline of the jitter metric is derived from the observed jitter metric values at t1, t2, t3, t4, t5, . . . , tz; the baseline of the latency metric is derived from the observed latency metric values at t1, t2, t3, t4, t5, . . . , tz; and the baseline of the packet loss metric is derived from the observed packet loss metric values at t1, t2, t3, t4, t5, . . . , tz.

The “Standard Deviation” row of Table 1 includes the standard deviation values derived for each of the four performance metrics, based on the observed metric values at the different time points and based on the respective baselines. The standard deviation of each of the four performance metrics (bandwidth utilization, jitter, latency, and packet loss) is computed according to Eq. 1 above.

The “Normalized Standard Deviation” row of Table 1 includes the normalized standard deviation values derived for each of the four performance metrics. A normalized standard deviation of a performance metric can range in value between [−1 and 1]. A negative normalized standard deviation refers to a standard deviation that is on a first side of the baseline, while a positive normalized standard deviation refers to a standard deviation that is on a second side of the baseline.

Note that performance metric values are continually being received by the network path selector 120 as probe packets are sent by the probe engine 122. Thus, the baselines and standard deviations are also continually being updated. Thus, there may be multiple standard deviations computed over time for each performance metric, including a current standard deviation σ_{current}(m(x)) for metric m(x), where x∈{bandwidth utilization, jitter, latency, packet loss}. Prior standard deviations were also computed for metric m(x). The standard deviation σ_{current}(m(x)) is computed according to Eq. 1.

For the current standard deviation σ_{current}(m(x)), a normalized standard deviation σ_{current}(m(x))_{Normalized} is computed as:

$${{σ}_{current} ( m ( x ) )}_{Normalized} = \frac{{σ}_{avg} ( m ( x ) ) - {σ}_{current} ( m ( x ) )}{{σ}_{max} ( m ( x ) ) - {σ}_{min} ( m ( x ) )} , \qquad ( Eq . 2 )$$

where σ_{avg}(m(x)) is the average of the last N (N>1) standard deviations that have been computed for the uplink, σₘₐₓ(m(x)) is the maximum of the last N standard deviations for the uplink, and σₘᵢₙ(m(x)) is the minimum of the last N standard deviations for the uplink.

Given the four normalized standard deviation values for uplink U1, σ(bandwidth utilization)_{Normalized}, σ(jitter)_{Normalized}, σ(latency)_{Normalized}, and σ(packet loss)_{Normalized}, a normalized aggregate uplink path score, Path_Score(U1)_{Normalized}, for uplink U1 is derived according to Eqs. 3 and 4.

$$Path\_Score {( U 1 )}_{Aggregate} = {σ ( bandwidth utilization )}_{Normalized} + {σ ( jitter )}_{Normalized} + {σ ( latency )}_{Normalized} + {σ ( packet loss )}_{Normalized} , \qquad ( Eq . 3 )$$

where Eq. 3 produces an aggregate uplink path score, Path_Score(U1)_{Aggregate}, for uplink U1, which is the sum of the normalized standard deviation values for the bandwidth utilization, jitter, latency, and packet loss metrics.

Similar computations for uplinks U2, U3, and U4 produce respective aggregate uplink path scores, Path_Score(U2)_{Aggregate}, Path_Score(U3)_{Aggregate}, and Path_Score(U4)_{Aggregate}. Given the aggregate uplink path scores for uplinks U1, U2, U3, and U4, the normalized aggregate uplink path score, Path_Score(U1)_{Normalized}, for uplink U1 is computed as:

$$Path\_Score {( U 1 )}_{Normalized} = \frac{Path\_Score {( U 1 )}_{Aggregate} - Avg\_Aggr \_Path \_Score}{Max\_Aggr \_Path \_Score - Min\_Aggr \_Path \_Score} , \qquad ( Eq . 4 )$$

where Avg_Aggr_Path_Score is the average of Path Score(U1)_{Aggregate}, Path_Score(U2)_{Aggregate}, Path_Score(U3)_{Aggregate}, and Path_Score(U4)_{Aggregate}, Max_Aggr_Path Score is the maximum of Path_Score(U1)_{Aggregate}, Path_Score(U2)_{Aggregate}, Path_Score(U3)_{Aggregate}, and Path_Score(U4)_{Aggregate}, and Min_Aggr_Path Score is the minimum of Path_Score(U1)_{Aggregate}, Path_Score(U2)_{Aggregate}, Path_Score(U3)_{Aggregate}, and Path_Score(U4)_{Aggregate}.

The normalized aggregate uplink path score for uplink U1 according to Eq. 4 and Table 1 is −0.016938832.

Table 2 below includes four columns representing the bandwidth, jitter, latency, and packet loss of uplink U2.

TABLE 2
(Uplink U2)

| | Bandwidth | | | |
|---|---|---|---|---|
| | Utilization | Jitter | Latency | Packet Loss |
| | (%) | (millisecond) | (millisecond) | (%) |
| t1 | 36 | 11.250 | 57.5 | 0.05625 |
| t2 | 59 | 52.500 | 70.0 | 1.01250 |
| t3 | 80 | 43.125 | 35.0 | 0.95625 |
| t4 | 19 | 13.125 | 32.5 | 0.20625 |
| t5 | 83 | 3.750 | 122.5 | 1.18125 |
| tz | . . . | . . . | . . . | . . . |
| Baseline | 55 | 58.01 | 98.20 | 0.93333 |
| Standard | 24.8241 | 19.3188 | 32.6573 | 0.4586 |
| Deviation | | | | |
| Normalized | 0.170957968 | 0.58370352 | 0.157065327 | −0.488391943 |
| Standard | | | | |
| Deviation | | | | |

The normalized aggregate uplink path score, Path_Score(U2)_{Normalized}, for uplink U2 is computed as:

$$Path\_Score {( U 2 )}_{Normalized} = \frac{Path\_Score {( U 2 )}_{Aggregate} - Avg\_Aggr \_Path \_Score}{Max\_Aggr \_Path \_Score - Min\_Aggr \_Path \_Score} . \qquad ( Eq . 5 )$$

The normalized aggregate uplink path score for uplink U2 according to Eq. 5 and Table 2 is 0.163564198.

TABLE 3
(Uplink U3)

| | Bandwidth | | | |
|---|---|---|---|---|
| | Utilization | Jitter | Latency | Packet Loss |
| | (%) | (millisecond) | (millisecond) | (%) |
| t1 | 58 | 35.625 | 107.5 | 0.43125 |
| t2 | 9 | 9.375 | 2.5 | 0.11250 |
| t3 | 81 | 35.625 | 142.5 | 0.69375 |
| t4 | 95 | 150.000 | 190.0 | 0.93750 |
| t5 | 41 | 5.625 | 45.0 | 0.67500 |
| tz | . . . | . . . | . . . | . . . |
| Baseline | 62 | 87.01 | 124.20 | 0.8533 |
| Standard | 30.26813 | 52.9055 | 68.2816 | 0.2792 |
| Deviation | | | | |
| Normalized | −0.642977231 | −0.41629648 | −0.54867101 | 0.12410379 |
| Standard | | | | |
| Deviation | | | | |

The normalized aggregate uplink path score, Path_Score(U3)_{Normalized}, for uplink U3 is computed as:

$$Path\_Score {( U 3 )}_{Normalized} = \frac{Path\_Score {( U 3 )}_{Aggregate} - Avg\_Aggr \_Path \_Score}{Max\_Aggr \_Path \_Score - Min\_Aggr \_Path \_Score} . \qquad ( Eq . 6 )$$

The normalized aggregate uplink path score for uplink U3 according to Eq. 6 and Table 3 is −0.573312683.

TABLE 4
(Uplink U4)

| | Bandwidth | | | |
|---|---|---|---|---|
| | Utilization | Jitter | Latency | Packet Loss |
| | (%) | (millisecond) | (millisecond) | (%) |
| | 38 | 28.125 | 50.0 | 0.65625 |
| | 39 | 73.125 | 95.0 | 0.63750 |
| | 81 | 144.375 | 80.0 | 0.82500 |
| | 97 | 15.000 | 97.5 | 1.05000 |
| | 75 | 88.342 | 66.7 | 0.96572 |
| Baseline | 56 | 92.32 | 77.30 | 0.76823 |
| Standard | 23.5796 | 46.1652 | 17.8034 | 0.1657 |
| Deviation | | | | |
| Normalized | 0.357022769 | −0.215612877 | 0.45132899 | 0.511608057 |
| Standard | | | | |
| Deviation | | | | |

The normalized aggregate uplink path score, Path_Score(U4)_{Normalized}, for uplink U4 is computed as:

$$Path\_Score {( U 4 )}_{Normalized} = \frac{Path\_Score {( U 4 )}_{Aggregate} - Avg\_Aggr \_Path \_Score}{Max\_Aggr \_Path \_Score - Min\_Aggr \_Path \_Score} . \qquad ( Eq . 7 )$$

The normalized aggregate uplink path score for uplink U4 according to Eq. 7 and Table 4 is 0.426687317.

Table 5 lists example normalized performance metric values for datacenters DC1 and DC2, including a normalized bandwidth factor, a normalized power usage effectiveness, a normalized energy efficiency, a normalized reliability, and a normalized throughput. Although five specific performance metrics are depicted in Table 5, it is noted that in different examples different performance metrics may be employed.

The last column of Table 5 is a normalized aggregate datacenter score derived by computing an aggregate (according to Eq. 11 or 12 further below) of the normalized bandwidth factor, the normalized power usage effectiveness, the normalized energy efficiency, the normalized reliability, and the normalized throughput.

TABLE 5

| | Normalized | Normalized | Normalized | | | |
|---|---|---|---|---|---|---|
| | Bandwidth | Power Usage | Energy | Normalized | Normalized | Normalized |
| | Factor | Effectiveness | Efficiency | Reliability | Throughput | Aggregate |
| Datacenter | (0-1) | (0-1) | (0-1) | (0-1) | (0-1) | DC score |
| DC1 | 0.90122 | 0.64323 | 0.92341 | 0.95676 | 0.80098 | 0.5 |
| DC2 | 0.92234 | 0.55536 | 0.91234 | 0.94565 | 0.81232 | −0.5 |

Each normalized performance metric value in Table 5 is obtained using the following formula:

$${Metric}_{Normalized} = \frac{( Average\_Metric - Metric Value )}{( Max\_Metric - Min\_Metric )} , \qquad ( Eq . 8 )$$

where Metric Value represents the value of the performance metric (e.g., bandwidth factor), Average_Metric represents the average of the values of the performance metric across the two datacenters DC1 and DC2 (e.g., the average of the values of the bandwidth factor in DC1 and DC2), Max_Metric represents the maximum of the values of the performance metric across the two datacenters DC1 and DC2 (e.g., the maximum of the values of the bandwidth factor in DC1 and DC2), and Min_Metric represents the minimum of the values of the performance metric across the two datacenters DC1 and DC2 (e.g., the minimum of the values of the bandwidth factor in DC1 and DC2). Using Eq. 8, the following normalized DC performance metrics are obtained for DC1: Bandwidth_Factor(DC1)_{Normalized}, Power_Usage_Effectiveness(DC1)_{Normalized}, Energy_Efficiency(DC1)_{Normalized}, Reliability(DC1)_{Normalized}, and Throughput(DC1)_{Normalized}. The following normalized DC performance metrics are obtained for DC2: Bandwidth_Factor(DC2)_{Normalized}, Power_Usage_Effectiveness(DC2)_{Normalized}, Energy Efficiency(DC2)_{Normalized}, Reliability(DC2)_{Normalized}, and Throughput(DC2)_{Normalized}.

An aggregate DC score for DC1 is computed as:

$$DC\_Score {( D C 1 )}_{A g gregate} = Bandwidth\_Factor {( D C 1 )}_{N o r m a l i z e d} + Power\_Usage \_Effectiveness {( DC 1 )}_{N o r m a l i z e d} + Energy\_ Efficiency {( DC 1 )}_{N o r m a l i z e d} + Reliability {( DC 1 )}_{N o r m a l i z e d} + {Throughput ( DC 1 )}_{N o r m a l i z e d} . \qquad ( Eq . 9 )$$

An aggregate DC score for DC2 is computed as:

$$DC\_Score {( DC 2 )}_{A g gregate} = Bandwidth\_Factor {( DC 2 )}_{N o r m a l i z e d} + Power\_Usage \_Effectiveness {( DC 2 )}_{N o r m a l i z e d} + Energy\_ Efficiency {( DC 2 )}_{N o r m a l i z e d} + Reliability {( DC 2 )}_{N o r m a l i z e d} + {Throughput ( DC 2 )}_{N o r m a l i z e d} . \qquad ( Eq . 10 )$$

The normalized aggregate DC score for DC1 is computed as:

$$DC\_Score {( D C 1 )}_{N o r m a l i z e d} = \frac{DC\_Score {( D C 1 )}_{A g gregate} - Avg\_Aggr \_DC \_Score}{Max\_Aggr \_DC \_Score - Min\_Aggr \_DC \_Score} , \qquad ( Eq . 11 )$$

where Avg_Aggr_DC_Score is the average of DC_Score(DC1)_{Aggregate} and DC_Score(DC2)_{Aggregate}, Max_Aggr_DC_Score is the maximum of DC_Score(DC1)_{Aggregate} and DC_Score(DC2)_{Aggregate}, and Min_Aggr_DC_Score is the minimum of DC_Score(DC1)_{Aggregate} and DC_Score(DC2)_{Aggregate}.

The normalized aggregate DC score for DC2 is computed as:

$$DC\_Score {( DC 2 )}_{N o r m a l i z e d} = \frac{DC\_Score {( DC 2 )}_{A g gregate} - Avg\_Aggr \_DC \_Score}{Max\_Aggr \_DC \_Score - Min\_Aggr \_DC \_Score} . \qquad ( Eq . 12 )$$

Table 6 shows an example of a normalized final aggregate score computed for each of uplinks U1 to U4. The “Normalized Final Aggregate Score” column of Table 6 includes a normalized final aggregate score for each uplink calculated by computing a product of the normalized aggregate uplink path score (derived according to Eqs. 4-7) and the respective normalized aggregate DC score (derived according to Eqs. 11 and 12).

The normalized final aggregate scores for uplinks U1, U2, U3, and U4 are computed according to Eqs. 17-20 below.

An aggregate final score, Final_Score(U1)_{Aggregate}, for uplink U1 is computed as:

$$Final\_Score {( U 1 )}_{A g gregate} = Path\_Score {( U 1 )}_{N o r m a l i z e d} + DC\_Score {( D C 1 )}_{A g gregate} . \qquad ( Eq . 13 )$$

An aggregate final score, Final_Score(U2)_{Aggregate}, for uplink U2 is computed as:

$$Final\_Score {( U 2 )}_{A g gregate} = Path\_Score {( U 2 )}_{N o r m a l i z e d} + DC\_Score {( D C 1 )}_{A g gregate} . \qquad ( Eq . 14 )$$

An aggregate final score, Final_Score(U3)_{Aggregate}, for uplink U3 is computed as:

$$Final\_Score {( U 3 )}_{A g gregate} = Path\_Score {( U 3 )}_{N o r m a l i z e d} + DC\_Score {( D C 2 )}_{A g gregate} . \qquad ( Eq . 15 )$$

An aggregate final score, Final Score(U4)_{Aggregate}, for uplink U4 is computed as:

$$Final\_Score {( U 4 )}_{A g gregate} = Path\_Score {( U 4 )}_{N o r m a l i z e d} + DC\_Score {( D C 2 )}_{A g gregate} . \qquad ( Eq . 16 )$$

From the foregoing, the normalized final aggregate score, Final_Score(U1)_{Normalized}, for uplink U1 is computed as:

$$Final\_Score {( U 1 )}_{N o r m a l i z e d} = \frac{Final\_Score {( U 1 )}_{A g gregate} - Avg\_Aggr \_Final \_Score}{Max\_Aggr \_Final \_Score - Min\_Aggr \_Final \_Score} , \qquad ( Eq . 17 )$$

where Avg_Aggr_Final_Score is the average of Final_Score(U1)_{Aggregate}, Final_Score(U2)_{Aggregate}, Final_Score(U3)_{Aggregate}, and Final_Score(U4)_{Aggregate}, Max_Aggr_Final Score is the maximum of Final_Score(U1)_{Aggregate}, Final_Score(U2)_{Aggregate}, Final_Score(U3)_{Aggregate}, and Final_Score(U4)_{Aggregate}, and Min_Aggr_Final_Score is the minimum of Final_Score(U1)_{Aggregate}, Final_Score(U2)_{Aggregate}, Final_Score(U3)_{Aggregate}, and Final_Score(U4)_{Aggregate}.

Similarly, the normalized final aggregate score, Final_Score(U2)_{Normalized}, for uplink U2 is computed as:

$$Final\_Score {( U 2 )}_{N o r m a l i z e d} = \frac{Final\_Score {( U 2 )}_{A g gregate} - Avg\_Aggr \_Final \_Score}{Max\_Aggr \_Final \_Score - Min\_Aggr \_Final \_Score} . \qquad ( Eq . 18 )$$

Similarly, the normalized final aggregate score, Final_Score(U3)_{Normalized}, for uplink U3 is computed as:

$$Final\_Score {( U 3 )}_{N o r m a l i z e d} = \frac{Final\_Score {( U 3 )}_{A g gregate} - Avg\_Aggr \_Final \_Score}{Max\_Aggr \_Final \_Score - Min\_Aggr \_Final \_Score} . \qquad ( Eq . 19 )$$

Similarly, the normalized final aggregate score, Final_Score(U4)_{Normalized}, for uplink U4 is computed as:

$$Final\_Score {( U 4 )}_{N o r m a l i z e d} = \frac{Final\_Score {( U 4 )}_{A g gregate} - Avg\_Aggr \_Final \_Score}{Max\_Aggr \_Final \_Score - Min\_Aggr \_Final \_Score} . \qquad ( Eq . 20 )$$

Thus, the normalized final aggregate score for uplink U1 is an aggregate that is based on the normalized aggregate uplink path score for uplink U1 and the normalized aggregate DC score of the datacenter (in this case DC1) to which uplink U1 is connected. Similarly, the normalized final aggregate score for uplink U2 is an aggregate that is based on the normalized aggregate uplink path score for uplink U2 and the normalized aggregate DC score of the datacenter (in this case DC1) to which uplink U2 is connected; the normalized final aggregate score for uplink U3 is an aggregate that is based on the normalized aggregate uplink path score for uplink U3 and the normalized aggregate DC score of the datacenter (in this case DC2) to which uplink U3 is connected; and the normalized final aggregate score for uplink U4 is an aggregate that is based on the normalized aggregate uplink path score for uplink U4 and the normalized aggregate DC score of the datacenter (in this case DC2) to which uplink U4 is connected.

TABLE 6

| | Normalized | | |
|---|---|---|---|
| | Aggregate | Normalized | |
| | Uplink Path | Aggregate DC | Normalized Final |
| Uplink | Score | Score | Aggregate Score |
| Uplink U1 | −0.016938832 | 0.5 | 0.278120558 |
| Uplink U2 | 0.163564198 | 0.5 | 0.382044465 |
| Uplink U3 | −0.573312683 | −0.5 | −0.617955535 |
| Uplink U4 | 0.426687317 | −0.5 | −0.042209488 |

More generally, a final aggregate score for a given uplink is based on computing a mathematical aggregation of an uplink path score for the given uplink and a computing environment score of the computing environment to which the given uplink is connected. The uplink path score for the given uplink can itself be an aggregate of multiple performance metrics of the given uplink. The uplink path score for the given uplink can be normalized to be within a given range of values, such as in the range [−1, 1] or in any other range of values. Similarly, the computing environment score for a computing environment can be normalized to be within the given range of values.

Based on the normalized final aggregate scores for uplinks U1 to U4 in Table 6, uplink U2 has the highest normalized final aggregate score. The network path selector 120 can select uplink U2 for communicating traffic of a client. In other examples, network path selector 120 can select multiple uplinks for communicating traffic of a client. In such latter examples, according to Table 6, uplinks U1 and U2 have higher normalized final aggregate scores than uplinks U3 and U4, and thus the network path selector 120 can select uplinks U1 and U2 for communicating traffic of a client.

More generally, M (M≥1) uplinks can be selected for communicating traffic of a given set of clients. If M>1, then the traffic of the given set of clients can be distributed across the M uplinks according to relative values of normalized final aggregate scores of the M uplinks. For example, if uplink U(q) has normalized final aggregate score S(q) and uplink U(r) has normalized final aggregate score S(r), then the distribution of the traffic of the given set of clients across uplinks U(q) and U(r) can be as follows: a first percentage

$$( \frac{S q )}{S ( q ) + S ( r )} )$$

of the given's client traffic is transferred over uplink U(q), and a second percentage

$$( \frac{S ( r )}{S ( q ) + S ( r )} )$$

of the given's client traffic is transferred over uplink U(r). More generally, given M>1 selected uplinks, a percentage of the given's client traffic transferred over uplink U(i), where i=1 to M, is computed as

$$\frac{S ( i )}{{\sum }_{j = 1}^{M} S ( j )} . \qquad ( Eq . 21 )$$

Effectively, the network path selector 120 apportions traffic from a set of clients to the computing environment(s) across a first selected uplink and a second selected uplink according to a ratio based on normalized final aggregate scores of the first selected uplink and the second selected uplink.

The following describes various examples of how a baseline is computed, such as baseline values in Tables 1 to 4 above. A baseline value of a performance metric (e.g., bandwidth utilization, jitter, latency, or packet loss) may be computed using a baselining algorithm. In an example, the baselining algorithm may produce a baseline based on any or some combination of the following: a mean of the performance metric values, a median of the performance metric values, a most frequent value of the performance metric values, a maximum value of the performance metric values, a moving average of the performance metric values, a Z-score (also referred to as a standard score) of the performance metric values, a value produced by seasonality trend decomposition, a baseline value produced by a neural network, or a baseline value produced by a machine learning model. Given a historical set of performance metric values collected over a given time interval, the network path selector 120 (or another entity) can calculate the baseline based on the set of performance metric values.

The most frequent value of the performance metric values is determined by identifying which value of the performance metric values occurs most frequently in the set of performance metric values. An example of a neural network that can be employed for generating a baseline based on the set of performance metric values is a Long Short-Term Memory (LSTM) recurrent neural network.

Baseline values can be updated by the baselining algorithm, such as at regular intervals or in response to other events. A regular interval can include an interval of a given number of hours, a day, a given number of days, a week, or any other time interval.

In examples where a machine learning model is used to produce a baseline value, the set of performance metric values can be provided as an input to the machine learning model, and the machine learning model produces an output (the baseline value) based on the input. In some examples, the machine learning model can be a support vector machine (SVM), such as a one-class SVM.

The machine learning model (e.g., an SVM) can be trained using a training data set of performance metric values. The training data set can indicate what baseline values correspond to what sets of performance metric values.

An example of a one-class SVM is a nu-SVM, as described in a reference entitled “sklearn.svm.NuSVC,” downloaded from https://scikit-learn.org/stable/modules/generated/sklearn.svm.NuSVC.html#sklearn.svm.NuSVC, on Oct. 12, 2023. The nu-SVM includes various tunable hyperparameters, such as gamma and nu. Gamma controls the number of decision thresholds. A smaller value of gamma, e.g., 0.1, may return fewer decision thresholds (baselines), while a larger value of gamma, e.g., >1, may return a larger number of decision thresholds (baselines). The nu hyperparameter controls the percentage of data considered to be outliers. Nu is a hyperparameter of a nu-SVM that is tuned based on data distribution.

In some examples, a large set of performance metric values can be split into smaller data blocks without altering the distribution of the data. Data splitting is performed so that the distribution of each data block after splitting remains the same, which can be achieved if the variance of the original set of performance metric values and the variance of each data block after splitting are almost the same, e.g., the variance each data block is [90-110] % of the variance of original set of performance metric values. The nu hyperparameter can be tuned over multiple training cycles. This helps to ensure that the machine learning algorithm produces results in a more timely manner. Baselining has exponential time complexity, so determining a baseline value based on an input set of performance metric values may be costly in terms of processing resources consumed. The splitting of a large set of performance metric values can be split into smaller blocks can allow the nu-SVM to more efficiently determine a baseline value.

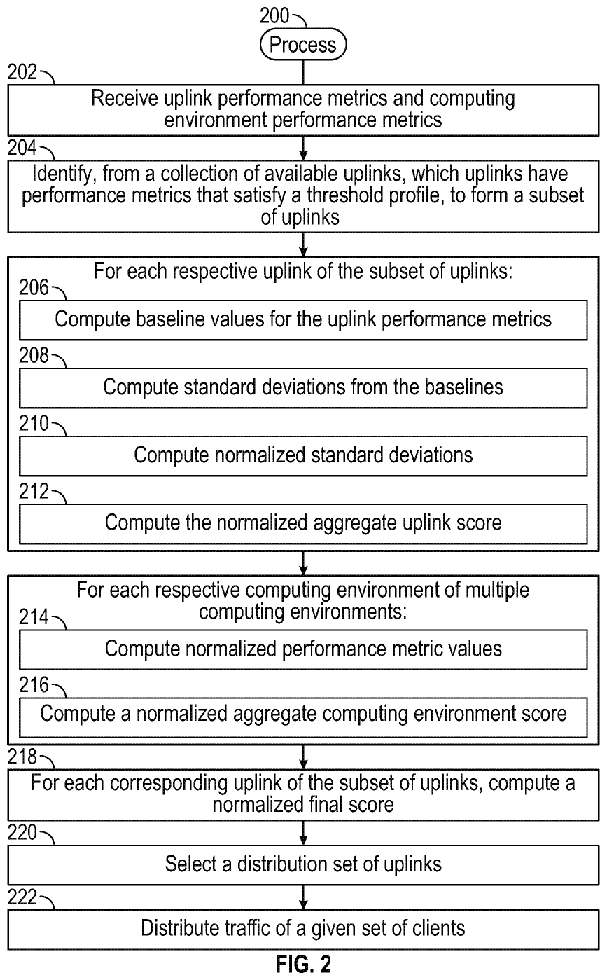

FIG. 2 is a flow diagram of a process 200 performed by the network path selector 120 of FIG. 1, according to some examples. The process 200 is initiated in response to a request received at the branch gateway 114 that traffic is to be sent upstream to one or more computing environments for a given set of clients. The network path selector 120 receives (at 202) uplink performance metrics (e.g., 134 retrieved from the memory 132 of FIG. 1) and computing environment performance metrics (e.g., 136 retrieved from the memory 132 of FIG. 1).

The network path selector 120 identifies (at 204), from a collection of available uplinks to computing environments, which uplinks of the collection of available uplinks have uplink performance metrics that satisfy thresholds in the threshold profile (included in the SLA information 138 of FIG. 1 for example) for the data flow of the given set of clients. The uplinks that satisfy thresholds in the threshold profile form a subset of uplinks. The subset of uplinks can include less than all of the uplinks in the collection of available uplinks, or can include all of the uplinks in the collection of available uplinks. For example, if the collection of available uplinks includes uplinks U1A, U2A, U3A, U1B, U2B, and U3B of FIG. 1, then the subset of uplinks can include some portion of U1A, U2A, U3A, U1B, U2B, and U3B.

For each respective uplink of the subset of uplinks, the network path selector 120 computes (at 206, 208, 210, and 212) the following values. The network path selector 120 computes (at 206) baseline values for the uplink performance metrics (e.g., bandwidth utilization, jitter, latency, and packet loss) of the respective uplink, such as depicted in Tables 1 to 4 above. The network path selector 120 computes (at 208) standard deviations from the baselines for the uplink performance metrics of the respective uplink. The network path selector 120 computes (at 210) normalized standard deviations for the uplink performance metrics of the respective uplink. The network path selector 120 computes (at 212) the normalized aggregate uplink score based on the normalized standard deviations for the performance metrics of the respective uplink.

For each respective computing environment of multiple computing environments to which the subset of uplinks are connected, the network path selector 120 computes (at 214 and 216) the following values. The network path selector 120 computes (at 214) normalized performance metric values for the respective computing environment (such as for datacenter DC1 or DC2 in Table 5 above). The normalized performance metric values can include a normalized bandwidth factor, a normalized power usage effectiveness, a normalized energy efficiency, a normalized reliability, and/or a normalized throughput, as shown in Table 5. The network path selector 120 computes (at 216) a normalized aggregate computing environment score, such as the normalized aggregate datacenter score in the last column of Table 5 above.

For each corresponding uplink of the subset of uplinks, network path selector 120 computes (at 218) a normalized final score for the corresponding uplink based on aggregating the normalized aggregate uplink score of the corresponding uplink and the normalized aggregate computing environment score of the computing environment to which the corresponding uplink is connected.

The network path selector 120 selects (at 220) a distribution set of uplinks (including M≥1) uplinks to use for transferring traffic of the given set of clients. If M>1, then the network path selector 120 can distribute (at 222) the traffic of the given set of clients proportionally, such as according to Eq. 21 above.

In some examples, the traffic of a given session of a client is sent over the same uplink (i.e., the traffic of the given session of the client is not distributed across multiple uplinks). A “session” can refer to any separately identifiable communication of data established using a session establishment process. For example, the session may be identified by a session identifier.

The network path selector 120 is able to monitor available uplinks using measured performance metrics responsive to probe packets sent by the probe engine 122 of FIG. 1. Based on the monitoring, the network path selector 120 is able to identify the uplinks that satisfy the threshold profile of a client, and select uplink(s) to use for the client's traffic based on aggregate performance scores, such as the normalized final scores discussed above. The aggregate performance scores are based on performance indicators of both uplinks and of computing environments. The performance indicators of uplinks can be based on standard deviations computed from baselines of performance metrics for the uplinks.

In examples where multiple uplinks are selected for a client, traffic of a given communication session of the client can be forwarded to one or multiple computing environments.

The network path selector 120 is able to adapt the selection of network paths dynamically to adjust to loads and performance of the uplinks and computing environments, and demands of clients. Changing conditions will cause the network path selector 120 to change uplink selections. If a different uplink is to be used for an existing session, then a new uplink is selected for use and an existing uplink is deselected according to a make-before-break technique which ensures that the new uplink is available for use before the existing uplink is deselected. In this way, a client is able to obtain seamless connectivity.

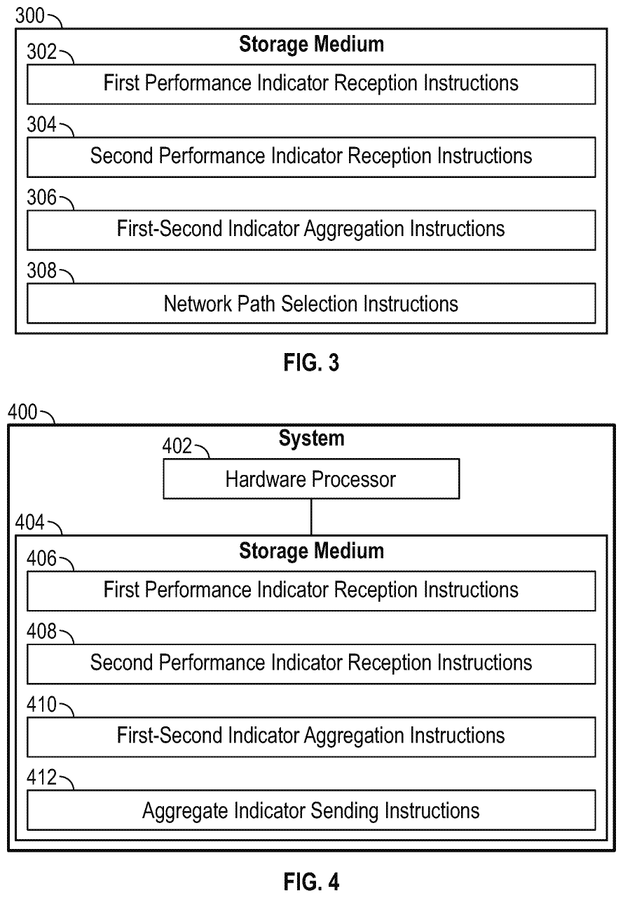

FIG. 3 is a block diagram of a non-transitory machine-readable or computer-readable storage medium 300 storing machine-readable instructions that upon execution cause a network device to perform various tasks. The network device may be the branch gateway 114 of FIG. 1, for example.

The machine-readable instructions include first performance indicator reception instructions 302 to receive first indicators of performances of a plurality of computing environments, such as 102-A and 102-B in FIG. 1. The first indicators can include the normalized computing environment scores (e.g., the normalized aggregate DC scores computed according to Eqs. 11 and 12 discussed above).

The machine-readable instructions include second performance indicator reception instructions 304 to receive second indicators of performances of a plurality of network paths (e.g., U1A, U2A, U3A, U1B, U2B, and U3B in FIG. 1) from the network device to the computing environments. The second indicators can include network path scores (e.g., the normalized aggregate uplink scores (e.g., the normalized aggregate uplink path scores according to Eqs. 4-7 discussed above).

The machine-readable instructions include first-second indicator aggregation instructions 306 to aggregate the first indicators and second indicators to produce aggregate indicators of performances of the network paths. The aggregate indicators can include normalized final aggregate scores according to Eqs. 17-20 discussed above in connection with Table 6, for example.

The machine-readable instructions include network path selection instructions 308 to select, at the network device based on the aggregate indicators, a selected network path of the plurality of network paths for communication of data through the network device between a client and a computing environment of the plurality of computing environments.

In some examples, for each respective network path of the plurality of network paths, the machine-readable instructions compute a baseline based on measured values of a metric representative of the performance of the respective network path, and compute the second indicator of the performance of the respective network path based on the baseline. In some examples, the baseline is computed by a machine learning model, such as an SVM.

In some examples, for each respective network path of the plurality of network paths, the machine-readable instructions compute a standard deviation of the measured values of the metric relative to the baseline. The second indicator of the performance of the respective network path is based on the standard deviation.

In some examples, the metric is a first metric and the baseline is a first baseline. The machine-readable instructions further compute a second baseline based on measured values of a second metric representative of the performance of the respective network path. The second indicator of the performance of the respective network path is further based on the second baseline.

In some examples, the machine-readable instructions cause the network device to send probe packets along the plurality of network paths, obtain measured values of a metric representative of the performances of the plurality of network paths based on the probe packets, and derive the second indicators based on the measured values of the metric.

In some examples, the machine-readable instructions identify priorities associated with a plurality of clients. The selected network path is for the client associated with a higher priority than another client of the plurality of clients.

In some examples, the selected network path is a first selected network path for communication of data of a set of clients, and the aggregate indicators determine a selection, at the network device based on the aggregate indicators, a second selected network path of the plurality of network paths for communication of data through the network device between the set of clients and the computing environment.

In some examples, the second indicator of the performance of the first selected network path has a first value, and the second indicator of the performance of the second selected network path has a second value. The network device apportions data from the set of clients to the computing environment across the first selected network path and the second selected network path according to a ratio based on the first value and the second value (and possibly other values).

In some examples according to FIG. 3, various computations are performed at the network device, such as at the branch gateway 114 of FIG. 1. In other examples, as shown in FIG. 4, the computations may be performed by a system 400 that is separate from a network device such as the branch gateway 114.

The system 400 includes a hardware processor 402 (or multiple hardware processors) and a storage medium 404 that stores machine-readable instructions. A hardware processor can include a microprocessor, a core of a multi-core microprocessor, a microcontroller, a programmable integrated circuit, a programmable gate array, or another hardware processing circuit.

The machine-readable instructions are executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include first performance indicator reception instructions 406 to receive first indicators of performances of a plurality of computing environments.

The machine-readable instructions in the storage medium 404 include second performance indicator reception instructions 408 to receive second indicators of performances of a plurality of network paths from a network device to the computing environments.

The machine-readable instructions in the storage medium 404 include first-second indicator aggregation instructions 410 to aggregate the first indicators and second indicators to produce aggregate indicators of performances of the network paths.

The machine-readable instructions in the storage medium 404 include aggregate indicator sending instructions 412 to send, from the system 400, the aggregate indicators to the network device. The aggregate indicators are useable at the network device to select, based on the aggregate indicators, a selected network path of the plurality of network paths for communication of data through the network device between a client and a computing environment of the plurality of computing environments.

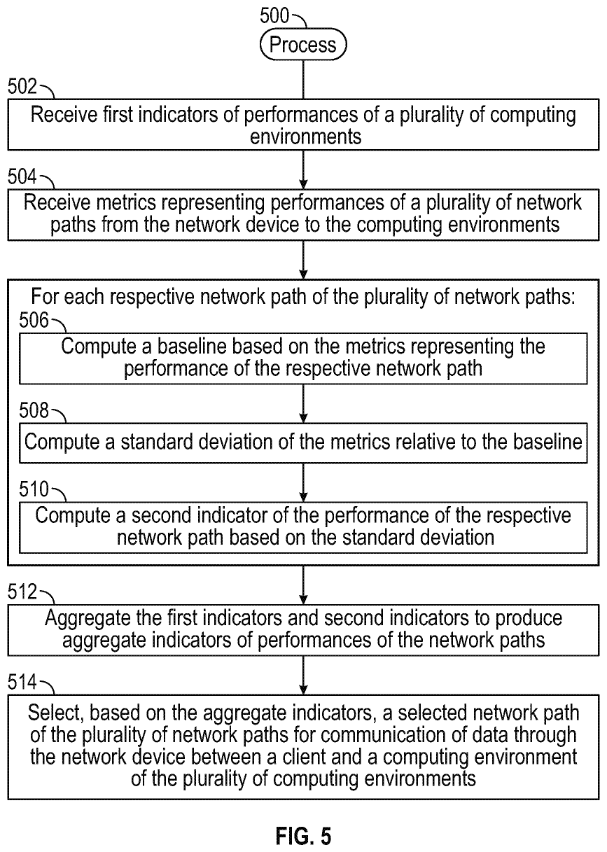

FIG. 5 is a flow diagram of a process 500, which can be performed by a network device, for example. The process 500 includes receiving (at 502), at a network device, first indicators of performances of a plurality of computing environments. The process 500 includes receiving (at 504), at the network device, metrics representing performances of a plurality of network paths from the network device to the computing environments. The metrics can include a bandwidth utilization of a network path, a jitter of a network path, a latency of a network path, or a packet loss of a network path.

For each respective network path of the plurality of network paths, the network device computes (at 506) a baseline based on the metrics representing the performance of the respective network path, computes (at 508) a standard deviation of the metrics relative to the baseline, and computes (at 510) a second indicator of the performance of the respective network path based on the standard deviation. The baseline is computed using a baselining algorithm. The standard deviation is computed according to Eq. 1, for example. The computations at 506, 508, and 510 produce multiple second indicators for the plurality of network paths.

The process 500 includes aggregating (at 512) the first indicators and second indicators to produce aggregate indicators of performances of the network paths. The aggregate indicators can include the normalized final aggregate scores according to Eqs. 17-20, for example.

The process 500 includes selecting (at 514), based on the aggregate indicators, a selected network path of the plurality of network paths for communication of data through the network device between a client and a computing environment of the plurality of computing environments.

A storage medium (e.g., 300 in FIG. 3 or 404 in FIG. 4) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a network device to:
receive first indicators of performances of a plurality of computing environments;
receive second indicators of performances of a plurality of network paths from the network device to the computing environments;
aggregate the first indicators and second indicators to produce aggregate indicators of performances of the network paths; and
select, at the network device based on the aggregate indicators, a selected network path of the plurality of network paths for communication of data through the network device between a client and a computing environment of the plurality of computing environments.

2. The non-transitory machine-readable storage medium of claim 1, wherein the instructions upon execution cause the network device to:
for each respective network path of the plurality of network paths:
compute a baseline based on measured values of a metric representative of the performance of the respective network path, and
compute the second indicator of the performance of the respective network path based on the baseline.

3. The non-transitory machine-readable storage medium of claim 2, wherein the instructions upon execution cause the network device to:
compute a standard deviation of the measured values of the metric relative to the baseline,
wherein the second indicator of the performance of the respective network path is based on the standard deviation.

4. The non-transitory machine-readable storage medium of claim 2, wherein the metric is selected from among a bandwidth utilization of the respective network path, a jitter of the respective network path, a latency of the respective network path, or a packet loss of the respective network path.

5. The non-transitory machine-readable storage medium of claim 2, wherein the metric is a first metric and the baseline is a first baseline, and wherein the instructions upon execution cause the network device to:
compute a second baseline based on measured values of a second metric representative of the performance of the respective network path,
wherein the second indicator of the performance of the respective network path is further based on the second baseline.

6. The non-transitory machine-readable storage medium of claim 2, wherein the instructions upon execution cause the network device to:
compute the baseline using a machine learning model that receives as input the measured values of the metric.

7. The non-transitory machine-readable storage medium of claim 1, wherein the instructions upon execution cause the network device to:
cause the network device to send probe packets along the plurality of network paths;
obtain measured values of a metric representative of the performances of the plurality of network paths based on the probe packets; and
derive the second indicators based on the measured values of the metric.

8. The non-transitory machine-readable storage medium of claim 1, wherein the instructions upon execution cause the network device to:
compute the first indicator of the performance of a first computing environment of the plurality of computing environments based on a metric relating to one or more of power usage or energy efficiency of the first computing environment.

9. The non-transitory machine-readable storage medium of claim 1, wherein the instructions upon execution cause the network device to:
compute the first indicator of the performance of a first computing environment of the plurality of computing environments based on a metric relating to one or more of a bandwidth factor, a reliability, a throughput, a heating, ventilation, and air conditioning (HVAC) efficiency, a greenness measure, a security measure, or a financial impact measure of the first computing environment.

10. The non-transitory machine-readable storage medium of claim 1, wherein the instructions upon execution cause the network device to:
identify priorities associated with a plurality of clients,
wherein the selected network path is for the client associated with a higher priority than another client of the plurality of clients.

11. The non-transitory machine-readable storage medium of claim 1, wherein the selected network path is a first selected network path for communication of data of a set of clients, and wherein the aggregate indicators determine a selection, at the network device based on the aggregate indicators, a second selected network path of the plurality of network paths for communication of data through the network device between the set of clients and the computing environment.

12. The non-transitory machine-readable storage medium of claim 11, wherein the second indicator of the performance of the first selected network path has a first value, and the second indicator of the performance of the second selected network path has a second value, and wherein the network device is to apportion data from the set of clients to the computing environment across the first selected network path and the second selected network path according to a ratio based on the first value and the second value.

13. The non-transitory machine-readable storage medium of claim 12, wherein the first value is based on a first standard deviation of a metric of the performance of the first selected network path, and the second value is based on a second standard deviation of a metric of the performance of the second selected network path.

14. The non-transitory machine-readable storage medium of claim 1, wherein the selected network path is associated with a metric that satisfies a threshold profile for a data flow of the client.

15. The non-transitory machine-readable storage medium of claim 1, wherein the first indicators are based on multiple performance metrics associated with each of the plurality of computing environments, and the second indicators are based on multiple performance metrics associated with each of the plurality of network paths.

16. A system comprising:
a hardware processor; and
a non-transitory storage medium comprising instructions executable on the hardware processor to:
receive first indicators of performances of a plurality of computing environments;
receive second indicators of performances of a plurality of network paths from a network device to the computing environments;
aggregate the first indicators and second indicators to produce aggregate indicators of performances of the network paths; and
send, from the system, the aggregate indicators to the network device, the aggregate indicators useable at the network device to select, based on the aggregate indicators, a selected network path of the plurality of network paths for communication of data through the network device between a client and a computing environment of the plurality of computing environments.

17. The system of claim 16, wherein the instructions executable on the hardware processor to:
for each respective network path of the plurality of network paths:
compute a baseline based on measured values of a metric representative of the performance of the respective network path, and
compute the second indicator of the performance of the respective network path based on the baseline.

18. The system of claim 17, wherein the instructions executable on the hardware processor to:
compute a standard deviation of the measured values of the metric relative to the baseline,
wherein the second indicator of the performance of the respective network path is based on the standard deviation.

19. A method comprising:
receiving, at a network device, first indicators of performances of a plurality of computing environments;
receiving, at the network device, metrics representing performances of a plurality of network paths from the network device to the computing environments;
for each respective network path of the plurality of network paths:
computing, at the network device, a baseline based on the metrics representing the performance of the respective network path,
computing, at the network device, a standard deviation of the metrics relative to the baseline, and
compute a second indicator of the performance of the respective network path based on the standard deviation,
wherein multiple second indicators are computed for the plurality of network paths;
aggregating, by the network device, the first indicators and second indicators to produce aggregate indicators of performances of the network paths; and
selecting, at the network device based on the aggregate indicators, a selected network path of the plurality of network paths for communication of data through the network device between a client and a computing environment of the plurality of computing environments.

20. The method of claim 19, wherein the computing of the baseline uses a machine learning model that receives as input the metrics representing the performance of the respective network path.
